(19) United States
(12) Patent Application Publication
(10) Pub. No.: US 2026/0291112 A1
(43) Pub. Date: Sep. 24, 2026

(54) ELECTRICAL PLUG CONNECTOR WITH IMPROVED CO2 FOOTPRINT

(71) Applicant: HARTING International Innovation AG, Biel (CH)

(72) Inventors: Christian Cording, Wagenfeld (DE); Fabrizia Ghezzo, Biel/Bienne (CH); Benjamin Krüger, Osnabrück (DE); Thomas Heimann, Rahden (DE); Valeri Fink, Bad Oeynhausen (DE)

(73) Assignee: HARTING International Innovation AG, Biel (CH)

(21) Appl. No.: 19/469,893

(22) PCT Filed: Apr. 4, 2023
(86) PCT No.: PCT/EP2023/058886

§ 371 Date: Sep. 26, 2025

(51) Int. Cl. H01R 13/46

(52) U.S. Cl. CPC H01R 13/46

(57) ABSTRACT

The present invention relates to an electrical connector with one or more plastic components, wherein at least one of the plastic components comprises a sustainable polymer. The use of sustainable polymers in one or more plastic components of an electrical connector allows the production of sustainable electrical connectors that are characterized by an improved CO₂ footprint.

The present invention relates to an electrical connector with one or more plastic components, wherein at least one of the plastic components comprises a sustainable polymer. The use of sustainable polymers in one or more plastic components of an electrical connector allows the production of sustainable electrical connectors that are characterized by an improved CO₂ footprint.

### PRIOR ART

Electrical connectors typically have one or more components made of plastic. These include, for example, insulator bodies, locking mechanisms, protective covers, cable glands and housings. Modularly constructed connectors enable the combination of a variety of individual connector modules, which are typically combined with one another in a housing via a holding frame. The individual connector modules, but also the housing and the holding frame can be designed as plastic components.

In the course of recent years, sustainability and in particular the carbon dioxide balance have come into focus for the production of electrical connectors. Thus, it is a declared goal of the European Union to bring about a reduction of harmful greenhouse gases by 55% compared to 1990 by 2030, and climate neutrality is aimed for by 2050.

For each (industrial) product, the so-called CO₂ footprint (carbon footprint, CFP) can be determined as a measure of its CO₂ balance. The CFP of a product is typically determined within the framework of a Life-Cycle Assessment according to ISO 14040/140044 (in the version valid on the filing date).

Typically, polymers based on petroleum are used for the production of plastic components for electrical connectors and connector modules. These include, for example, polymers such as acrylonitrile-butadiene-styrene copolymers (ABS), polyamide (PA) or polycarbonate (PC). This creates a major disadvantage from environmental perspectives, as these products are burned after their life cycle with high energy input and release of environmentally harmful greenhouse gases.

It is known to use sustainable raw materials to reduce the CO₂ footprint of an industrial product. For example, US2016/0237353 A1 describes flame-retardant block copolymers that are produced from renewable raw materials, such as polylactide. The described block copolymers can be used in various industrial products. Electrical connectors are subject to very strict requirements, particularly with regard to low flammability. The block copolymers described in US2016/0237353 A1 achieve reduced flammability by copolymerizing a phosphorus-containing polymer. Corresponding block copolymers are characterized by high synthesis effort, whereby cost-effective production of electrical connectors is not possible.

In view of the above statements, there is therefore a need to be able to provide electrical connectors that are characterized by an improved CO₂ balance, that meet industrial requirements regarding flammability and can be produced cost-effectively at the same time.

### PROBLEM STATEMENT

It is therefore the object of the present invention to provide an electrical connector with an improved CO₂ balance. The electrical connector according to the invention should have at least comparable, preferably improved, performance properties with regard to its mechanical and electrical properties. Furthermore, the connector according to the invention should have reduced flammability and be able to be produced cost-effectively.

The object is solved by an electrical connector with one or more plastic components, wherein at least one plastic component comprises one or more sustainable polymers.

A second subject of the present invention is also a plastic component for an electrical connector containing one or more sustainable polymers.

A third subject of the present invention is also the use of a sustainable polymer in at least one plastic component of an electrical connector for reducing the CO₂ footprint of the electrical connector.

For better understanding of the invention, the following explanations of the terminology used herein are considered useful. Within the meaning of the invention:
“sustainable polymer” is a collective term for all polymers that are based on natural or recycled raw materials and are not a direct product of exclusively petrochemical production. In particular, the term sustainable polymers includes natural oil-based and/or bio-based polymers, but also polymers that are processed through a recycling process in such a way that they can be used as plastic directly or as starting material for the production of a polymer. In contrast, the term “synthetic polymer” describes a polymer that is derived from petroleum or petroleum products.
“a”, “an” as an article before a chemical compound class, e.g. before the word “polymer”, that one or more compounds falling under this chemical compound class, e.g. various polymers can be meant. In a preferred embodiment, only a single compound is meant by this article;
“at least one” numerically “one or more”. In a preferred embodiment, this term means numerically “one”;
“contain”, “comprise” and “include”, that in addition to the mentioned components, others may still be present. These terms are meant inclusively and therefore also include “consist of”. “Consist of” is meant conclusively and means that no further components can be present. In a preferred embodiment, the terms “contain”, “comprise” and “include” mean the term “consist of”.

Within the meaning of the present invention, the term “electrical connector” also includes modularly constructed connectors in which at least two or more individual connector modules are combined with one another.

An electrical connector within the meaning of the present invention typically comprises one or more components made of plastic (colloquially also referred to as plastic component(s)). The term plastic here refers to a solid that predominantly comprises a polymeric matrix that contains one or more polymers. Preferably, the proportion of the polymeric matrix in the plastic is at least 70 wt. %, more preferably at least 80 wt. %, more preferably 90 wt. %, even more preferably at least 95 wt. %, even more preferably at least 98 wt. %. Further components of the plastic can be, for example, organic and/or inorganic fillers that are added to the polymer matrix to adjust certain properties of the resulting plastic.

According to the invention, at least one plastic component of the electrical connector contains one or more sustainable polymers. However, it is also possible that two or more plastic components of the electrical connector comprise one or more sustainable polymers. In a particularly preferred embodiment of the invention, all plastic components of the connector contain one or more sustainable polymers.

Components of an electrical connector that are typically made of plastic are one or more insulator bodies, the housing, protective covers, cable glands and/or components of one or more locking mechanisms. If the electrical connector is modularly designed, a holding frame in the form of a plastic component can additionally be added.

The greater the proportion of sustainable polymers in the plastic components of the electrical connector, the lower the CO₂ footprint of the corresponding electrical connector. It is therefore preferred that, on the one hand, the weight percentage of the sustainable polymer in a plastic component is as high as possible and that as many as possible, preferably all plastic components, comprise one or more sustainable polymers.

Preferably, the weight percentage of the sustainable polymer based on the polymeric matrix of the plastic component is at least 30 wt. %, preferably at least 40 wt. %, preferably at least 50 wt. %, preferably at least 60 wt. %, preferably at least 70 wt. %, preferably at least 80 wt. %, preferably at least 90 wt. %, preferably at least 95 wt. %. Most preferably, the polymeric matrix of a plastic component consists of a sustainable polymer.

In one embodiment of the invention, the electrical connector comprises an insulator body as a plastic component, which comprises at least one sustainable polymer.

In a further embodiment of the invention, the electrical connector comprises a housing as a plastic component, which comprises at least one sustainable polymer.

In a further embodiment of the invention, the electrical connector comprises a protective cover as a plastic component, which comprises at least one sustainable polymer.

In a further embodiment of the invention, the electrical connector comprises a locking mechanism as a plastic component, which comprises at least one sustainable polymer.

In a preferred embodiment of the invention, the aforementioned embodiments regarding the specification of the plastic component can be combined with one another in any way, so that the electrical connector comprises more than one plastic component that contains at least one sustainable polymer.

In the aforementioned embodiments, it is particularly preferred that the polymeric matrix consists of one or more sustainable polymers. In other words, this means that no so-called “synthetic polymers” are used for the polymeric matrix. The term “synthetic polymer” is to be understood as polymers that are derived from petroleum or petroleum products.

As already stated above, the term sustainable polymer is to be understood as all polymers that are based on naturally occurring or recycled raw materials.

Naturally occurring raw materials for the production of a sustainable polymer can be derived from renewable raw materials, such as

from one or more natural oils. Corresponding polymers are also referred to as renewable or bio-based polymers.

The term “natural oil” within the meaning of the present invention is defined as a naturally occurring starting material that is not derived from petroleum. This includes in particular oils that originate from a plant, including its fruits, peels, nuts and/or seeds. However, animal fats and/or oils or any other oil not derived from petroleum can also be used. These naturally occurring materials are environmentally friendly and are also referred to as bio-based starting materials from which bio-based polymers are produced.

Examples of natural oils from which sustainable polymers can be produced are, for example, soybean oil, canola oil, sunflower oil, corn oil, linseed oil, poppy seed oil, cottonseed oil, tung oil, palm oil, peanut oil, fish oil, olive oil, safflower oil, rapeseed oil, coconut oil and castor oil.

The production of corresponding bio-based or renewable polymers is known to the person skilled in the art and will not be further elaborated here.

It is preferred that the sustainable polymer is a thermoplastic.

In a particularly preferred embodiment of the invention, the bio-based polymer comprises at least one thermoplastic polyester that was produced from naturally occurring raw materials. Preferably, the sustainable polymer is a thermoplastic polyester selected from the group consisting of polylactides (polylactic acids, PLA), polyhydroxyalkanoates (PHA) and mixtures thereof.

Polylactides (PLA), also known as polylactic acid, are bio-based and biodegradable/compostable polyesters that are produced from lactic acid and occur in two stereochemical forms or are present as their mixture. The monomeric lactic acid and the dimer (lactide) can be obtained sustainably through fermentation within the meaning of the present invention.

Sustainable polylactides are available, for example, under the trade name RENEW™ from futerro, such as RENEW™ 201. Further sustainable polylactides are available under the trade name Ingeo from NatureWorks or under the DAN series from Danimer Scientific.

Polyhydroxyalkanoates (PHA) are naturally occurring polyesters synthesized by bacteria from saturated and unsaturated hydroxyalkanoic acids. They exist either as homopolymers or as copolymers of various hydroxyalkanoic acids. Polyhydroxyalkanoates are thermoplastic, biodegradable, biocompatible and non-toxic.

Sustainable polyhydroxyalkanoates are available, for example, under the trade name IamNature from MAIP or under the product series PHACT from CJ Bio.

It is also possible that the bio-based polymer comprises at least one polyamide from sustainable sources, alone or in combination with the aforementioned bio-based polymers. Castor oil, for example, can be used as a sustainable starting material for the production of sustainable polyamides. Particularly preferred are polyamide 11 (PA11), polyamide 510 (PA510) and polyamide 1010 (PA1010).

Sustainable polyamides are available, for example, under the Rilsan product series from Arkema, under the Grilamid product series from EMS Chemie, under the Vestamin Terra product series from Evonik or under the trade name NB Bio PA11 from Nature Plast.

It is also possible that a recycled polymer is used as a sustainable polymer alone or in combination with the aforementioned bio-based polymers. The term “recycled polymer” within the meaning of the present invention refers to a polymer that is based on starting materials that were produced by recycling consumer goods or industrial (waste) products—such as clothing or fishing nets. The use of recycled polymers offers the advantage that environmentally harmful combustion processes for waste utilization can be avoided, whereby an additional positive effect regarding the CO₂ footprint can be achieved.

As already stated, polyamide can be used as a bio-based polymer, but it is also possible to use polyamide as a recycled polymer. Recycled polyamide can be obtained, for example, by recycling clothing. Within the meaning of the invention, it is preferred that polyamide is used as the recycled polymer, with PA6 or PA66 being particularly preferred. Recycled polyamides are available, for example, under the trade name Akulon from DMS or Agimid from Arkema.

In a preferred embodiment of the invention, the sustainable polymer comprises both at least one bio-based polymer and at least one recycled polymer.

In a further embodiment of the invention, it is also possible that the sustainable polymer is a hybrid copolymer of a bio-based polymer and a synthetic polymer. This form of sustainable polymers within the meaning of the present invention is also capable of reducing the CO₂ footprint of an electrical connector. As an example in this context, the commercially available product DURABIO from Mitsubishi Chemical can be mentioned as a hybrid copolymer.

In addition to the described polymeric matrix, the plastic for manufacturing the plastic component can contain further additives that positively influence the production and/or the properties of the plastic. These can be, for example, but not exclusively, dispersing additives, flow aids, adhesion promoters, wetting agents, flame retardants, colorants or fillers.

In one embodiment of the invention, the plastic comprises at least one filler, wherein the filler comprises glass fibers, whereby both the mechanical and thermal properties are improved. The impact resistance is also improved. Depending on the requirements, the weight percentage of filler, particularly glass fiber, in the plastic can be varied within a wide range. Preferably, the weight percentage is in a range from 10 wt. % to 50 wt. %, preferably in a range from 10 wt. % to 25 wt. %

In a further embodiment of the invention, the plastic further comprises halogen-free flame retardants, which comprise, for example, nitrogen and/or phosphorus compounds.

The production of the plastic components for the electrical connector is typically carried out by injection molding. Injection molding offers the advantage that production can be realized simply and cost-effectively.

Another subject of the present invention is also a plastic component for an electrical connector containing a sustainable polymer. Preferably, the plastic component according to the invention is an insulator body, a protective cover, a locking mechanism, a cable gland or a housing of an electrical connector. With regard to the plastic component according to the invention, all the above statements apply equally. If the electrical connector is a modularly constructed connector, a holding frame can also be present as a plastic component.

Another subject of the present invention is also the use of at least one sustainable polymer in at least one plastic component of an electrical connector for reducing the CO₂ footprint of the electrical connector.

Preferably, the plastic component is an insulator body, a protective cover, a locking mechanism, a cable gland and/or a housing of an electrical connector. In the case of a modularly constructed connector, the plastic component can also be a holding frame. In order to achieve the greatest possible reduction in the CO₂ footprint of the electrical connector, as many as possible, preferably all plastic components, of the electrical connector comprise one or more sustainable polymers. The sustainable polymers can be the same or different depending on the requirement profile of the plastic component. It is furthermore preferred that the proportion of the sustainable polymer(s) in the polymeric matrix is as large as possible. Preferably, therefore, the weight percentage of the sustainable polymer based on the polymeric matrix of the plastic component is at least 30 wt. %, preferably at least 40 wt. %, preferably at least 50 wt. %, preferably at least 60 wt. %, preferably at least 70 wt. %, preferably at least 80 wt. %, preferably at least 90 wt. %, preferably at least 95 wt. %. Most preferably, the polymeric matrix of a plastic component consists of a sustainable polymer, since this enables the greatest possible reduction in the CO₂ footprint of the electrical connector.

With regard to the use according to the invention, all the above statements apply equally, insofar as applicable.

1. Electrical connector comprising one or more plastic components, wherein at least one plastic component comprises one or more sustainable polymers.

2. Electrical connector according to claim 1, wherein the plastic component is selected from the group consisting of insulator bodies, housings, locking mechanisms, cable glands and protective covers.

3. Electrical connector according to claim 1, wherein the electrical connector is a modularly constructed connector.

4. Electrical connector according to claim 1, wherein the sustainable polymer is a bio-based polymer selected from the group consisting of bio-based polyesters, bio-based polyamides and mixtures thereof.

5. Electrical connector according to claim 4, wherein the bio-based polyester comprises polylactide (PLA) and/or polyhydroxyalkanoate.

6. Electrical connector according to 1, wherein the sustainable polymer is a recycled polymer.

7. Electrical connector according to claim 6, wherein the recycled polymer is produced from recycled consumer goods or industrial (waste) products.

8. Electrical connector according to claim 1, wherein the sustainable polymer comprises at least one bio-based polymer and at least one recycled polymer.

9. Electrical connector according to claim 1, wherein the plastic component comprises a filler, preferably glass fibers.

10. Electrical connector according to claim 1, wherein the at least one plastic component comprising the sustainable polymer is produced by injection molding.

11. Plastic component for an electrical connector containing one or more sustainable polymers.

12. Plastic component according to claim 11, wherein the plastic component is an insulator body, a locking mechanism, a protective cover or a housing of an electrical connector.

13. Plastic component according to claim 11, wherein the sustainable polymer is a bio-based polymer selected from the group consisting of bio-based polyesters, bio-based polyamides and mixtures thereof.

14. Use of at least one sustainable polymer in at least one plastic component of an electrical connector for reducing the CO2 footprint of the electrical connector.

15. Use according to claim 14, wherein the plastic component is an insulator body and/or a housing of an electrical connector.
